(19) United States
(12) Patent Application Publication
(10) Pub. No.: US 2008/0319793 A1
(43) Pub. Date: Dec. 25, 2008

(54) Method and commuication system for supporting the adherence to the study protocol of a clinical study

(76) Inventors: Helmut Myritz, Berlin (DE); Markus Schmidt, Nuernberg (DE); Gudrun Zahlmann, Neumarkt (DE)

Correspondence Address: HARNESS, DICKEY & PIERCE, P.L.C., P.O.BOX 8910, RESTON, VA, 20195, US

(21) Appl. No.: 12/213,155

(22) Filed: Jun. 16, 2008

(30) Foreign Application Priority Data
Jun. 18, 2007 (DE) 10 2007 027 919.3

(51) Int. Cl. G06Q 50/00

(52) U.S. Cl. 705/2

(57) ABSTRACT

In at least one embodiment of a method for supporting a person involved in a clinical study in the adherence to a study protocol, an automatic communication system is disclosed which collects data correlated with the performance of the study in at least approximately real time from a data processing system concerned with the study, determines, by use of the data, a first future time for a study action to be performed according to the study protocol, and, by use of a planning criterion, a second future time which is before the first one. In at least one embodiment, the communication system, at the second time, sends a message concerning the study action to the person. A corresponding communication system contains, in at least one embodiment, an interface for collecting the data, a control and evaluating unit for determining the first and second time, and a communication interface for sending the message.

### PRIORITY STATEMENT

The present application hereby claims priority under 35 U.S.C. §119 on German patent application number DE 10 2007 027 919.3 filed Jun. 18, 2007, the entire contents of which is hereby incorporated herein by reference.

### FIELD

Embodiments of the invention generally relate to a method and/or to a communication system for supporting a person who is involved in a clinical study with regard to the adherence to the study protocol of the clinical study.

### BACKGROUND

As part of clinical studies, software systems are already being used today. These are, e.g., study-supporting systems or data acquisition systems (Electronic Data Capture, EDC) etc. As a rule, these systems operate on a network basis and are accessible at the client of the study, e.g. a pharmaceutical company, and at selected access points in study sites, e.g. hospitals. There they are, e.g., computers which, however, are separate from the remaining IT structure of the hospital, e.g. a hospital information system, and cannot, therefore, communicate with it, either.

There is thus no connection between the network concerned with the study and the hospital IT system. This complicates the work in time-critical fields of application. E.g., deadline problems in the clinical study are often not recognized or are recognized too late, because of a lack of active assistance by software, and are not always conveyed to the responsible persons. These are, e.g., the study physicians, study nurses or other persons involved who do not happen to work at the special workstation in the hospital at which the study-supporting system is available.

An example of such a situation are strict time windows in performing patient examinations as a part of clinical studies. It is known here that the study assistants, that is to say the examining physicians, study nurses, etc., monitor these time windows and, if necessary, intervene in the case of deadline problems. Thus, e.g. the study nurse needs to react to potential deadline problems since she monitors critical time windows as part of the study protocol and should guarantee that they are adhered to.

Previous software systems such as, e.g., a workflow management system do assist but rarely offer active decision support. Previous study-supporting systems such as the abovementioned study management systems, EDC etc. provide assistance only in as far as a control, e.g. of elapsed times after study actions have taken place. A check whether a deadline was correctly adhered to thus only occurs after the event. If patients miss e.g. one or more deadlines, they drop out of the clinical study and suitable study participants then have to be recruited again. The associated increased time and cost expenditure can complicate the successful performance of a clinical study in this case or even cause it to fail. Preventing in advance the realization of an action violating the study protocol, e.g. its omission, is thus left only to the study assistant and thus greatly depends on the quality and the care taken in the study.

Known systems are often not very flexible and can therefore only be integrated with difficulty into the IT infrastructure already in existence. Since such systems can only be adapted extremely poorly to the complex requirements of a clinical study, the performance of the studies results in high error rates.

Although it is true that systems such as ChariTime (I. Munch, M. Gnoth, G. Lindemann: ChariTime—an agent-oriented software system for scheduling in a hospital, HU Spectrum 1/2002, ISBN 3-933490-01-4) attempt to relieve the medical personnel involved of decisions such as appointment agreements, these have hitherto found little acceptance.

### SUMMARY

In at least one embodiment of the present invention, a method and/or a communication system is specified which supports a person, involved in a clinical study, in the adherence to the study protocol.

In this context, at least one embodiment of the invention is based on the finding that the support by the method or the communication system, respectively, must take place at a time which is before a final last permitted time of a study action. At least one embodiment of the invention also makes use of the finding that, e.g., the persons involved in a clinical study cannot be contacted directly by the study-supporting system. In the field of clinical studies and patient administration, no decision-supporting systems have hitherto been successfully tried out as yet.

With regard to at least one embodiment of the method, a method is disclosed for supporting a person who is involved in a clinical study. At least one embodiment of the method supports the person in the adherence to the study protocol of the clinical study. In at least one embodiment of the method, an automatic communication system performs the following steps: firstly it collects data which are correlated with the performance of the study, from a data processing system which is concerned with the study. In this context, the data are collected at least approximately in real time. By way of the data, the communication system determines a first future time at which a study action has to be performed according to the study protocol. By way of a planning criterion, the communication system then determines a future second time which, however, is still before the first time, and, at the second time, sends a message concerning the study action to the person.

The persons involved in the study can be, for example, examining physicians, study nurses or also patients. Collecting the data from the data processing system approximately in real time means in other words that all data available as part of the clinical study in the data processing system can also be used for the method according to the invention as close to real time as possible. The communication system thus has a database which is always as current as possible, particularly with respect to the current course of the clinical study.

Developing at least one embodiment of such a communication system or method, respectively, makes it possible to create a flexible and scaleable structure which enables one to react in advance to deadline problems which relate to a study action at the first time which, in the context of the study protocol, represents the last possible time at which the study action has to be performed. In the case of a clinical study, patients, medical personnel and study assistants can thus for example be informed already at a second time, that is to say with a sufficient time interval before the first time, in order to still perform the study action in time. The data processing systems which can be used are all existing systems and databases which are utilized for the clinical study, e.g. systems for electronic data capture. In this arrangement, the data are periodically read out in real time, e.g., and thus represent status information with respect to the clinical study.

In other words, determining a first and second time determines a critical window for the study action and, by delivering the message, a measure is taken which can lead to informing the medical personnel and/or the study assistants in time. Both the study protocol and the current status of the performance of the study are acquired almost in real time, e.g. cyclically.

Conveying corresponding messages improves the communication between the parts or persons of a clinical study who otherwise communicate with one another clumsily, and thus increases the flexibility and also the quality of the performance of the study per se. A corresponding system also has potential in all similarly structured domains, that is to say not only clinical studies, in which efficiency is lost due to little communication between the individual parts of the domain. The potential consists in that the cost and time expenditure is distinctly reduced. In the case of the performance of clinical studies, these can be performed more rapidly and more safely; the additional expenditure for re-recruiting study participants does not apply or is distinctly reduced if fewer study actions are missed.

The automatic acquisition of the study protocol and of the patient status in the form of the data of each patient participating in the study and the independence from any other study-supporting systems are other important advantages of the communication system and method presented.

The person, the planning criterion and at least a part of the study protocol can be mapped in the communication system by a model which is dynamically dependent on the data. A corresponding model is particularly suitable for reacting to changing data, or the situations changing as a result, in the performance of the clinical study close to real time.

In particular, the persons, the planning criterion and at least a part of the study protocol can be mapped in the communication system by autonomous software agents. The roles of all involved persons in a time-critical environment are thus mapped by means of autonomous agents. The autonomous agents thus have the current study information in the form of the data, i.e. the mapped involved persons thus also have current information. The communication system can be flexibly adapted to the respective study environment by agent technology and can also be easily scaled to a greater number of patients.

The communication system can send out the message via any arbitrary or suitable communication channel, e.g. as E-mail, pager or voice message. The corresponding communication channels can be utilized by all involved persons intuitively, simply and with standardized aids. It is possible to utilize an existing infrastructure for communication.

The communication system can send at a third time, located between the first and second time, further messages with escalating steps increasing towards the first time. With increasing shortness of time, i.e. with approach to the first time, the involved persons hitherto informed, or additional ones, are reminded in escalating manner, i.e. with increasing urgency, of the completion of the study action or are respectively moved towards it, if possible.

The communication system can send the message on a communication channel which is usual for the person. The communication system herewith switches itself into the usual working environment in which the person is normally available continuously, that is to say close to real time, during the working time. This guarantees processing which is even closer to real time and thus an even greater probability that the study action will still be performed in time before the first time. It is particularly appropriate in this case to link the communication system to the IT structure of the study site so that all messages can flow into it and thus can always deliver to the person during their daily routine contact with the IT system.

With regard to at least one embodiment of the communication system, a communication system is disclosed for supporting a person involved in a clinical study in the adherence to the study protocol, comprising

an interface for collecting, at least approximately in real time, data correlated with the performance of the study from a data processing system concerned with the study,

a control and evaluating unit for determining a first time for a study action, to be performed according to the study protocol, by way of the data and for determining a second time, which is before the first one, for sending a message concerned with the study action to the person,

a communication interface for sending the message.

To collect the data, the communication system has a corresponding interface to the data processing system. The method according to at least one embodiment of the invention is performed in the communication system particularly by a control and evaluating unit which is used for determining the first and second time. To send the message, the communication system has a communication interface.

Apart from that, the communication system together with its advantages have already been explained in conjunction with the method according to at least one embodiment of the invention.

The control and evaluating unit can contain a model, which is dynamically dependent on the data, of the person, of the planning criterion and of at least a part of the study protocol.

The control and evaluating unit can contain autonomous software agents mapping the person, the planning criterion and at least a part of the study protocol.

The communication interface can be an E-mail, pager or voice interface.

The communication interface can be such to a communication channel which is usual for the person.

### BRIEF DESCRIPTION OF THE DRAWINGS

For a further description of the invention, reference is made to the example embodiments of the drawings, in which, in each case in a diagrammatic basic drawing:

FIG. 1 shows a hospital during the performance of a clinical study,

FIG. 2 shows a schedule for patient visits according to the study protocol before (a) and after (b) a modification according to an embodiment of the invention,

FIG. 3 shows a flowchart for the method according to an embodiment of the invention,

FIG. 4 shows a communication system according to an embodiment of the invention.

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

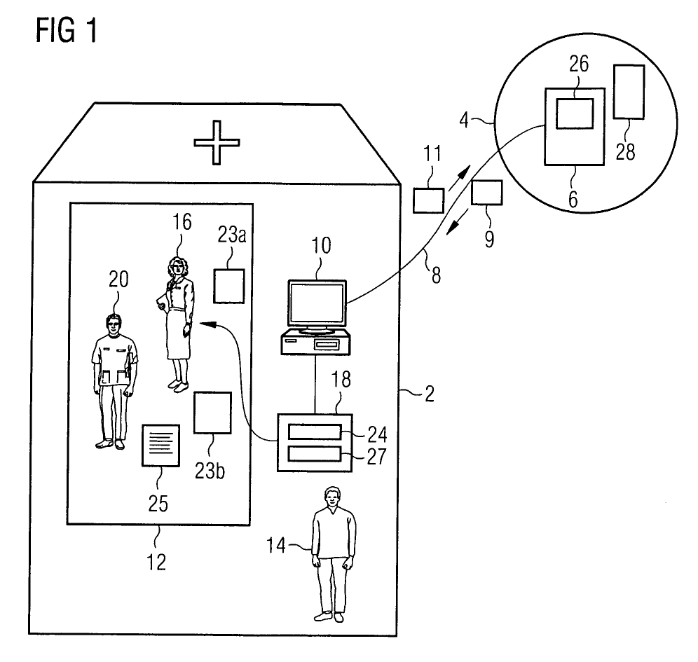

FIG. 1 shows a clinic 2 in which a clinical study is performed on behalf of a pharmaceutical company 4. For this purpose, the pharmaceutical company 4 has a study management system 6 which is connected to a PC 10 in the clinic 2 via a data line 8. The PC 10 is used for conveying job instructions 9 corresponding to the study protocol for the clinical study from the pharmaceutical company 4 to the clinic 2 and for reporting data 11 acquired on the patient from the clinic 2 to the pharmaceutical company 4.

According to the prior art, the PC 10 was hitherto decoupled from the remaining IT infrastructure, namely the intranet 12 of the clinic 2. Operating sequences in the intranet 12, e.g. also the scheduling with respect to a patient 14, thus occurred decoupled or autonomously from the study management system 6. The only persons responsible for adhering to the job instructions 9 visible on the PC 10 with respect to the clinical study were the personnel of the clinic 2 such as, e.g., a sister 16 or an examining physician 20.

According to an embodiment of the invention, the intranet 12 is now connected to the PC 10 and thus to the pharmaceutical company 4 or the study management system 6, respectively, via a communication system 18. As explained further below, the entire communication infrastructure in the form of the intranet 12 of the clinic 2 is rendered usable as communication medium as part of the clinical study via the communication system 18. The sister 16 and examining physician 20 and also the patient 14 can thus be reached directly on the study management system 6.

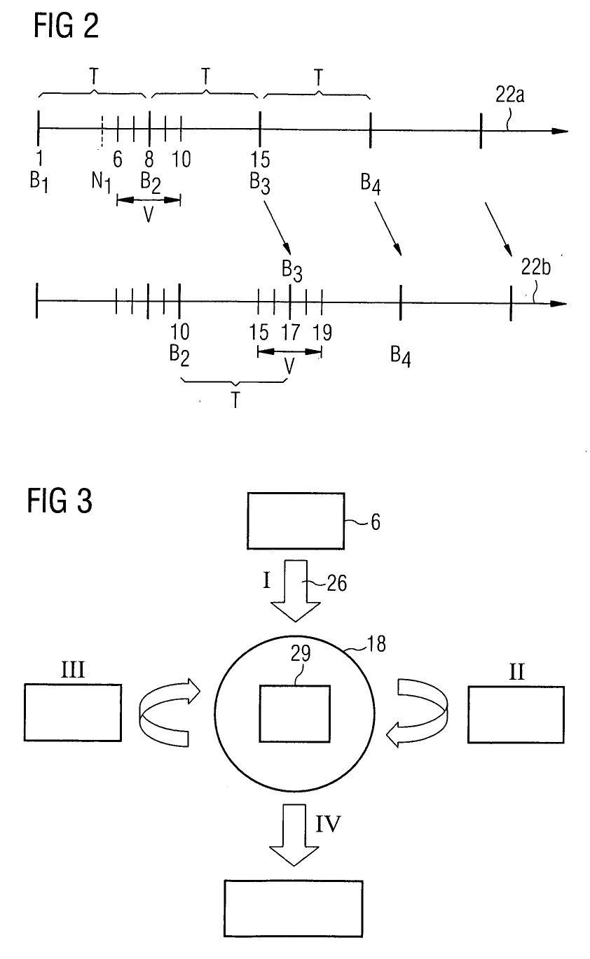

The clinical study performed in the clinic 2 provides for everyone, that is to say also the patient 14, that they make regular visits at the examining physician 20. According to the study protocol, the following rules exist for this:
the time T between two visits should be 7 days.
for each visit, there is a time window V of ±2 days with respect to the nominal deadline.
   A schedule 22a according to the study protocol is shown in FIG. 2.

According to the schedule 22a, the sister 16 organizes the visiting dates for the patient 14 and enters these in the study management system 6 via the PC 10. She also assists the examining physician 20 in the patient visits. The first date B1 is kept by the patient 14 on 01/05. Date B2 should thus occur after T, that is to say on 08/05, with a tolerance V from 06/05 to 10/05.

The communication system 18 correspondingly receives all this information via the study management system 6. In a controller 27, it determines, in accordance with a set of rules 24, 10/5 as last possible date L for the visit B2. Correspondingly, the communication system 18 determines 05/05 as message time N1. Since the sister 16 is working on the intranet 12 several times per day, she receives an E-mail 23a from the communication system 18 already on 05/05 that the time window V for the patient 14 applies from 06/05 until 10/05. Due to a predefined set of rules 24, the E-mail 23a is generated in the communication system 18 and accordingly delivered to the sister 16 on 05/05.

On the basis of the current study data 26, the communication system 18 finds on 08/05 that the patient 14 has not yet kept his date B2. According to the set of rules 24, the communication system 18 finds that 09/05 and 10/05 are now only available for the patient 14 for keeping his date B2, otherwise he will drop out of the clinical study according to the study protocol 28. On the basis of the set of rules 24, the communication system 18 therefore determines the date N2 as 08/05 and therefore composes a new E-mail 23b to the sister 16 and sends it to the intranet 12. Due to the higher escalation stage, i.e. urgency of the date, the communication system 18 also additionally generates a message 25 on the pager of the physician 20 in order to move the patient 14 to keep his date, together with the sister 16.

The sister 16 thereupon reminds the patient 14 urgently of the date still to be kept which had been forgotten by him. On 10/05, the patient 14 keeps his date B2 and the sister 16 enters this into the study management system 6, and thus the data 26, via the PC 10.

Since the communication system 18 now has the altered data 26, it can modify the schedule 22a to schedule 22b in deviation from the prior art (FIG. 2). Since namely the date B2 has now taken place in reality on 10/05, the nominal date B3 shifts to 17/05 and the permitted time window V shifts to 15/05 to 19/05. The communication system 18 can thus take into consideration the altered data 26 and inform the sister 16 adaptively about the new scheduling. Compared with the original schedule 22a, schedule 22b is thus adapted to the utilization of the time window V in the case of date B2, and the time interval T to date B3, which has thus shifted, etc., and as a consequence takes into consideration the additive shifts in deadline.

FIG. 3 shows a basic sequence of the method according to an embodiment of the invention in which the communication system 18 periodically reads data 26 out of a database in the form of the study management system 6 in a first step I. The communication system 18 makes these data 26 available as status information for the clinical study to a model 19 which maps the essential parts of the clinical study, of the participants (patient 14) and responsible persons (sister 16, physician 20). According to the data 26, the critical time window V according to FIG. 2 is recognized by the communication system 18 by processing the data 26 in step II. On the basis of the set of rules 24 from FIG. 1, the decision making takes place in step III, namely, e.g., to inform the sister 16 on 05/05. This takes place in step IV by sending out the abovementioned messages 23a, b and 25.

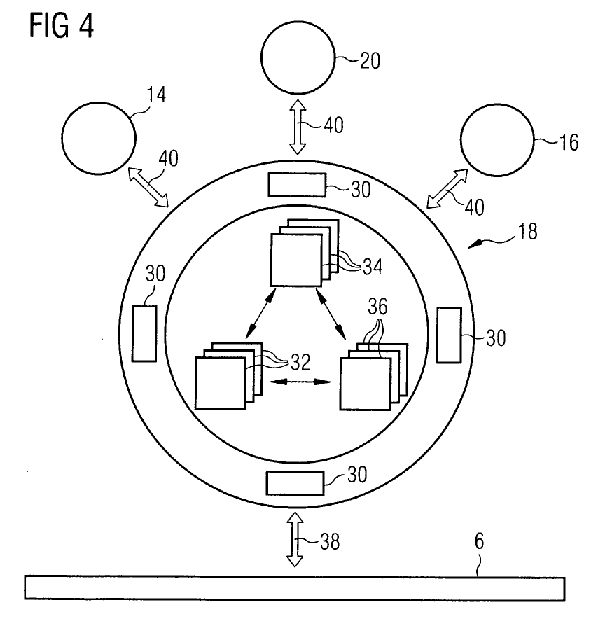

FIG. 4 shows the communication system 18 in detail. In the communication system 18, all patients 14 participating in the clinical study are represented by in each case one patient agent 32, all examining physicians 22 and sisters 16 are represented by personnel agents 34 and the study protocol 28 of the clinical study, boundary conditions, study information etc. are represented by study agents 36 as model 29.

The communication system 18 has various system agents 30 which, e.g., monitor the abovementioned remaining agents or control the communication. All agents are autonomous.

The communication system 18 also has a data interface 38 to the study management system 6 and various communication interfaces 40, e.g. to the real patients 14, the examining physician 20 or the sister 16, e.g. E-mail, pager, telephone, SMS interfaces.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program and computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a computer readable media and is adapted to perform any one of the aforementioned methods when run on a computer device (a device including a processor). Thus, the storage medium or computer readable medium, is adapted to store information and is adapted to interact with a data processing facility or computer device to perform the method of any of the above mentioned embodiments.

The storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for supporting a person involved in a clinical study in adherence to a study protocol, the method comprising:
collecting data correlated with a performance of the study in at least approximately real time from a data processing system associated with the study;
determining, using the collected data, a first time for a study action to be performed according to the study protocol;
determining, using a planning criterion, a second time before the first time; and
sending, at the determined second time, a message related to the study action to the person.

2. The method as claimed in claim 1, wherein the person, the planning criterion and at least a part of the study protocol are mapped by a model which is dynamically dependent on the data.

3. The method as claimed in claim 2, wherein the person, the planning criterion and at least a part of the study protocol are mapped by autonomous software agents.

4. The method as claimed in claim 1, wherein, as a message, at least one of an E-mail, pager, and voice message is sent.

5. The method as claimed in claim 1, wherein at least one third time, located between the first time and the second time, at least one further message is sent with escalating steps increasing towards the first time.

6. The method as claimed in claim 1, in which the message is sent on a communication channel which is usual for the person.

7. A communication system for supporting a person involved in a clinical study in adherence to a study protocol, comprising:
an interface to collect, at least approximately in real time, data correlated with performance of the study from a data processing system associated with the study;
a control and evaluating unit to determine a first time for a study action, to be performed according to the study protocol, using the collected data and to determine a second time, before the first time, for sending a message related to the study action to the person; and
a communication interface to send the message.

8. The communication system as claimed in claim 7, wherein the control and evaluating unit contains a model, which is dynamically dependent on the collected data of at least one of the person, the planning criterion and at least a part of the study protocol.

9. The communication system as claimed in claim 8, wherein the control and evaluating unit contains autonomous software agents mapping at least one of the person, the planning criterion and at least a part of the study protocol.

10. The communication system as claimed in claim 7, wherein the communication interface is at least one of an E-mail, pager and voice interface.

11. The communication system as claimed in claim 7, wherein the communication interface is one to a communication channel which is usual for the person.

12. The method of claim 1, further comprising using an automatic communication system to perform the method.

13. The method as claimed in claim 12, wherein the person, the planning criterion and at least a part of the study protocol are mapped in the communication system by a model which is dynamically dependent on the data.

14. The method as claimed in claim 13, wherein the person, the planning criterion and at least a part of the study protocol are mapped in the communication system by autonomous software agents.

15. The method as claimed in claim 12, wherein the communication system sends, as a message, at least one of an E-mail, pager, and voice message.

16. The method as claimed in claim 12, wherein the communication system sends at least one third time, located between the first time and the second time, at least one further message with escalating steps increasing towards the first time.

17. The method as claimed in claim 12, in which the communication system sends the message on a communication channel which is usual for the person.

18. The communication system as claimed in claim 8, wherein the control and evaluating unit contains autonomous software agents the person, the planning criterion and at least a part of the study protocol.

19. A communication system for supporting a person involved in a clinical study in adherence to a study protocol, comprising:
means for collecting data correlated with a performance of the study in at least approximately real time from a data processing system associated with the study;
means for determining, using the collected data, a first time for a study action to be performed according to the study protocol;
means for determining, using a planning criterion, a second time before the first time; and
means for sending, at the determined second time, a message related to the study action to the person.

20. A computer readable medium including program segments for, when executed on a computer device, causing the computer device to implement the method of claim 1.
